(19) United States
(12) Patent Application Publication
(10) Pub. No.: US 2026/0193799 A1
(43) Pub. Date: Jul. 9, 2026

(54) CELL FRAME FOR PRESSURIZED ELECTROLYSER CELL STACK AND ELECTROLYSER CELL STACK COMPRISING A NUMBER OF SUCH CELL FRAMES

(71) Applicant: thyssenkrupp nucera AG & Co. KGaA, Dortmund (DE)

(72) Inventors: Morten TVEDSKOV NIELSEN, Kolding (DK); Anders RØNNE RASMUSSEN, Kolding (DK)

(73) Assignee: thyssenkrupp nucera AG & Co. KGaA, Dortmund (DE)

(21) Appl. No.: 19/130,613

(22) PCT Filed: Nov. 17, 2023
(86) PCT No.: PCT/EP2023/082255

§ 371 Date: May 16, 2025

(30) Foreign Application Priority Data
Nov. 18, 2022 (DK) PA202201063

(51) Int. Cl. C25B 13/02; C25B 9/05; C25B 9/19; C25B 9/77

(52) U.S. Cl. CPC C25B 13/02; C25B 9/05; C25B 9/19; C25B 9/77

(57) ABSTRACT

A cell frame adapted for use in a pressurized electrolyser cell stack is provided. From an inner circumferential rim of the cell frame, a circumferential radial shelf with inwardly tapering thickness is provided, such that an annular space between a circumferential radial shelf and a neighboring circumferential radial shelf is provided when cell frames are stacked in alignment with each other, and that outwardly of the circumferential radial shelf, a mobility link is provided which connects the radial shelf to the remaining cell frame.

The present invention relates to a cell frame for a pressurised electrolyser cell stack. The invention further relates to an electrolyser cell stack comprising a number of such cell frames.

### BACKGROUND OF THE INVENTION

In electrolyser stacks, cell frames are arranged next to each other, and between frames, alternatingly, a diaphragm and a bipolar plate is provided. Similarly, alternating catholytic and anolytic chambers may be provided on each side of the diaphragms as well as on each side of the bipolar plates.

It is important that fluids do not flow between neighbouring anolytic and catholytic chambers, such as by leaking from one side of a diaphragm/bipolar plate to the other side thereof.

Such leaks may take place if there is no secure seal against passage of fluid around the edges of bipolar plates/diaphragm.

It is thus an objective of the present invention to ensure that anolyte and catholyte are not mixed in cells, during electrolysis, by fluid flow from one half cell to the next via flow paths around the rim of the diaphragms and/or bipolar plates in an electrolyser stack.

It is further an objective to ensure leak tight enclosures for the half cell processes in a new and patentably different way.

It is further an objective to ensure that possible engravings and unique marking of bipolar plates remain protected from the combined corrosive effects of the oxygen and the lye in individual half cells.

### SUMMARY OF THE INVENTION

Objects of the invention may be achieved in a first aspect of the invention by a cell frame according to claim 1.

A cell frame for a pressurised electrolyser cell stack is thus provided which from an inner circumferential rim of the cell frame has a circumferential radial shelf with inwardly tapering thickness, such that an annular space between a cell frame radial shelf and a neighbouring cell frame radial shelf is provided when cell frames are stacked in alignment with each other, and whereby outwardly of the radial shelf, a mobility link is provided which connects the radial shelf to the remaining cell frame.

The combined effect of the radial shelf and the mobility link ensures that the radial shelf may pivot and or translate slightly with respect to the remaining cell frame, and thus elements inserted in the annular space shall allow transfer of movement and thus pressurisation between the two opposed sides of the radial shelf. This movement of the radial shelf allows the radial shelf to compensate for possible deviations in tolerances in a member inserted in the annular space. In a stack comprising a multitude of cell frames, this construction ensures a more even distribution of force between the individual radial shelves and inserted elements in the annular spaces throughout the entire stack.

In an embodiment, the mobility link is comprised of an annular radial section with further reduced cell frame thickness.

Any other means of providing a mobility link, such as by joining the shelf to the cell by a flexible cement could be used, however a radial section with reduced thickness is easy to produce in injection moulded pieces and may also easily be modified and is thus preferred.

In an embodiment, the section with further reduced thickness has a thickness m which is no less than 10% and no more than 75% thinner than the nominal cell frame thickness t.

The compliance of the cell frame material allows the section with reduced thickness to work as a link between the cell frame and the inwardly directed circumferential radial shelf. The added compliance between the radial shelf and the remaining cell frame caused by the reduced thickness may easily be adjusted by changes to the injection mould tool.

In an embodiment, the mobility link in the cell frame radial direction extends no less than its further reduced thickness and no longer than three times its further reduced thickness.

The extent of the mobility link in radial and axial directions determines amongst others, whether the movement is purely pivotal or comprise a translational element in the length direction of the cell stack.

Objects of the invention may further be achieved by a second aspect of the invention concerning an electrolyser cell stack, for example as defined in claim 5.

The cell stack may comprise a number of cell frames, wherein the cell frames are urged against each other between end plates, and whereby consecutive cell frames in the stack alternatingly support a compliant diaphragm and a bipolar plate.

In this stack, the bipolar plates and the compliant diaphragm may be chosen with a thickness, such that when the frames are urged against each other between the end plates, there will always be a gasketing power between the cell frame and its accompanying bipolar plate/diaphragm.

In an embodiment, the bipolar plate and the compliant diaphragm both have a diameter which is no larger than the outer diameter of the mobility link furrow and no smaller than the inner diameter of the mobility link furrow.

In this way, the diaphragm is pressured along its entire edge part between the radial shelves of the consecutive cell frames between which it rests. Thereby it is ensured that the diaphragm remains in sealing contact with each of the two cell frames between which it is maintained. Likewise, the bipolar plates are pinched between the radial shelves on either side thereof. The construction allows for omission of actual gasketing materials between bipolar plates and the cell frames, and this is an important benefit, both in reduced complexity of the construction and in reduced assembly costs.

With the prescribed diameter restrictions, it is ensured that the diaphragms and bipolar plates will fit inside the annular space in its radial direction. Preferably, the diameter of the bipolar plates is a trifle smaller than the outermost diameter of the mobility link furrow, in order to ensure, that the bipolar plate does not inadvertently become pinched between two consecutive cell frames in a region, where the frames are supposed to lie flat against each other. The mobility link furrow defines the mobility link, as the furrow outlines the remaining cell frame material in the mobility link.

In an embodiment of the electrolyser cell stack, the radial shelf is adapted to pivot and/or translate in the axial direction of a cell stack when two cell frames with a bipolar plate arranged between them are urged against each other.

This movability allows a translation of force and movement from one side of the radial shelf to the opposed side. And due to this translation of force and/or movement, minor irregularities caused by manufacturing tolerances may be absorbed in the compliant diaphragms.

In an embodiment of the electrolyser, the diaphragm provided between two neighbouring cell frames is adapted to be pinched between the two radial shelves of the two neighbouring cell frames when the radial shelves move due to the two bipolar plates arranged at opposed sides of the two neighbouring cell frames.

The diaphragm which is made from a somewhat sponge-like material, shall locally absorb the pinching movement, however as the diaphragm also comprises a resilient polymer element, it will maintain its elastic property, and thus continually work in a gasketing capacity and prevent fluid flow around the edges between its two sides. The pinching of the diaphragm hinges on the fact that the thickness of the diaphragm at least surpasses the minimum distance between consecutive cell frames in the annular space when cell frames with the oversize bipolar plates are urged against each other. This is ensured in that the average of the sum of the thicknesses of the diaphragm and the bipolar plate throughout the stack is above the nominal distance between two cell frames in the annular space.

In an embodiment, the annular space between neighbouring cell frames covers a rim part of each bipolar plate which is resting in the annular space, whereby the bipolar plate at this rim part comprises a product marking embedded in the bipolar plate material.

The bipolar plate is drenched in the chemically aggressive lye or electrolyte which at one side of the plate will also comprise oxygen, which adds to the degenerative effect on the metal surface parts of the bipolar plate. However, the outer rim regions of the bipolar plates arranged in a stack, shall reside in the annular space between radial shelves of consecutive cell frames, and in this area, the bipolar plate surface parts shall be somewhat shielded from the aggressive oxygen, and any surface marking will survive in this region. To further ensure the longevity of the marking, it is preferred to provide it on the cathodic side of the bipolar plate, where only very little oxygen will be present during use of the electrolyser.

In an embodiment, the product marking is provided by laser or etching and is coded for computerised recognition, such as a quick response (QR) code, bar-code or the like.

Bar or CR coding is commonplace, but in the present case, it is not evident, that the marking which constitute the code shall survive and remain readable. However, the placement of the code in the rim area of the bipolar plate, shall ensure, that it remains readable by computerised processing of photographs of it.

Various exemplifying and non-limiting embodiments both as to constructions and to methods of operation, together with additional objects and advantages thereof, will be best understood from the following description of specific exemplifying and non-limiting embodiments when read in conjunction with the accompanying drawings. The verbs “to comprise” and “to include” are used in this document as open limitations that neither exclude nor require the existence of unrecited features. The features recited in dependent claims are mutually freely combinable unless otherwise explicitly states. Furthermore, it is to be understood that the use of “a” or “an”, i.e. a singular form, throughout this document does not exclude a plurality.

### BRIEF DESCRIPTION OF THE DRAWINGS

In the following, the invention will be described in greater detail with reference to embodiments shown by the enclosed figures. It should be emphasized that the embodiments shown are used for example purposes only and should not be used to limit the scope of the invention.

FIG. 1 is a sectional enlarged view comprising the inner perimeter of a number of cell frames,

FIG. 2 shows the larger fraction of a cell stack 2 in a sectional view and slightly tipped, to show the upper side of a cell frame,

FIG. 3 is a 3D representation of a cell stack 3 with removed end plate, current injector, and insulation plate and shows the upper side of a cell frame 1,

FIG. 4 shows a sectional view through a radial shelf 5 and mobility link 19,

FIG. 5 shows the sectional view of FIG. 1, however, with inserted bipolar plates 11 and diaphragm 10, and

FIG. 6 is an enlarged plane view of a part of the bipolar plate.

### DETAILED DESCRIPTION OF THE EMBODIMENTS

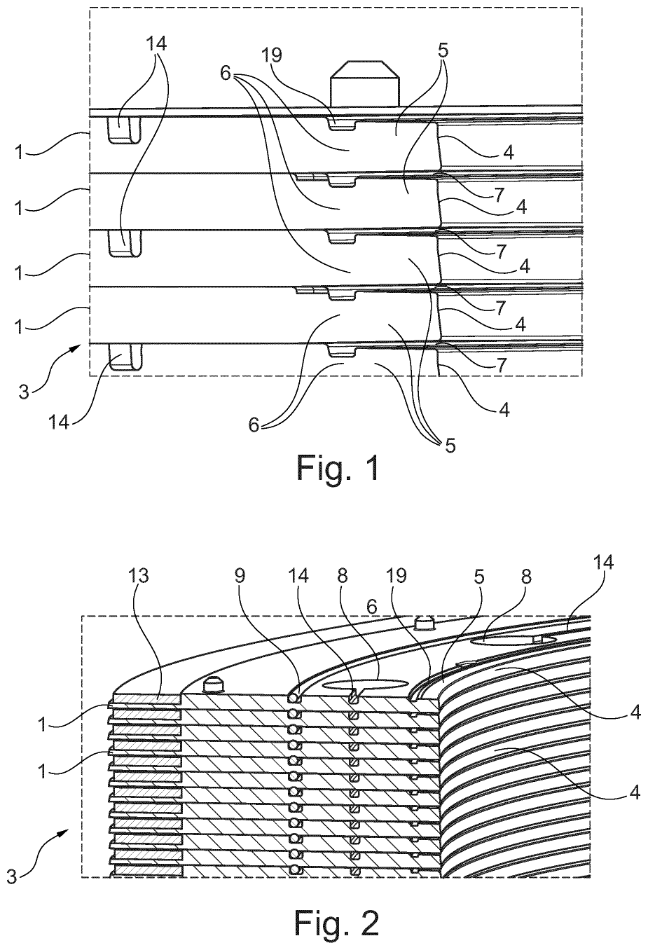

In FIG. 1, a sectional view of the inner perimeter part of a cell frame stack 3 with identical and stacked cell frames 1 is shown. The cell frame 1 shown at the uppermost position is rotated 180 degrees with respect to its neighbouring cell frame and is adapted to receive a diaphragm 10 which spans the area inside of the inner circular circumferential rim 4 of the cell frame 1. The second cell frame 1 in the stack is adapted to receive a bipolar plate 11. The first and the second cell frames are identical, however rotated around a cell stack length axis with respect to each other. In FIG. 2, a larger part of a cell stack 3 is shown, where a multitude of identical cell frames 1 are stacked on top of each other, where every other cell frame 1 is rotated 180 degrees about the cell stack axis. O-ring seals 9 are provided between each frame 1, and at an outer region of each cell frame 1, a steel ring 13 is mounted for safety reasons and to ensure containment of the internal pressure within the cell stack 3 during electrolysis. Electrolysers 3 of this build are used in pressurised alkalic electrolysis processes, and in the cell stacks, it is important to keep the electrolytic fluids in any two half cells separated and avoid cross diaphragm flows, which may compromise the purity of the released gasses in the two chambers. Especially when pressures between 30 and 100 bars are used, it may be a challenge to secure against fluid flows around the edges of diaphragms and bipolar plates.

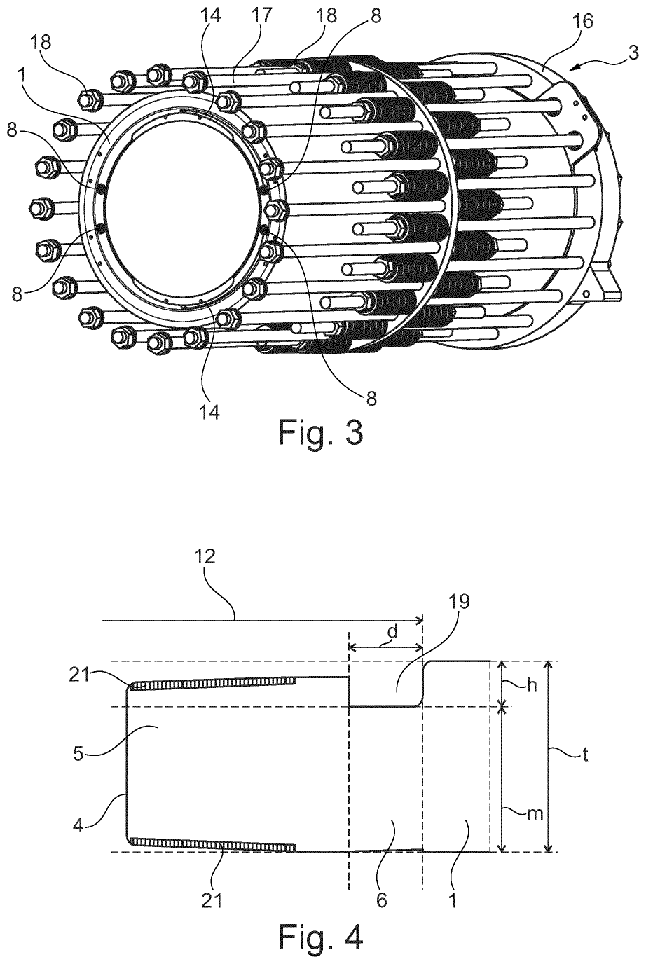

In FIG. 3, a 3D view of an electrolyser stack 3 is presented with some elements missing, such that a cell frame axial surface is visible. In FIGS. 1, 2, 4, and 5, the cell frames 1 are shown in a horizontal position, however, when the cell stack 3 is running as an electrolyser 3, it is usually placed with the cell frames stacked in a vertical or upright position as disclosed in FIG. 3. The cell stack length and centre axis are thus along a horizontal line in FIG. 3.

As seen in FIGS. 2 and 3, the cell frame 1 comprises 4 through-going openings 8, which serve as supply and discharge manifolds 8 to each half cell in the stack. From two of the openings, cell frame channels 14 are provided to inlet and outlet respectively. Any such two channels 14 and corresponding supply and discharge manifolds shall provide fluid communication to a half cell such as a catholytic chamber on a first side of a diaphragm 10. On an opposed side of the same diaphragm 10, an anolytic chamber is provided and shall be served by the two channels 14 in the next cell frame in the stack. To this end the next frame is mounted in a 180° rotational state around the length axis of the stack, such that the cell frame channels 14 and two corresponding supply and discharge manifolds 8 may form anolyte supply and discharge manifolds. In FIGS. 1, 2, and 5, the sectional view allows cell frame channels 14 in the displayed section to be seen in every second cell frame section.

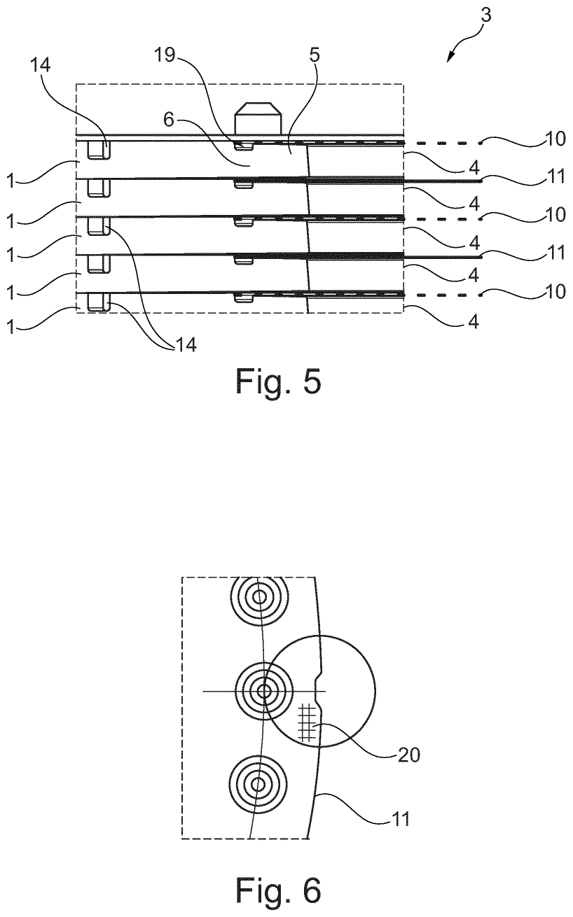

In FIG. 5, the diaphragms 10 and bipolar plates 11 are schematically indicated between each two cell frames 1. On each side of any diaphragm 10, an electrolytic chamber delimited by a bipolar plate 11 and the diaphragm 10 shall thus be provided. Electrodes which are not displayed in the drawings shall be provided at each side of the dipolar plates 11 and adapted to abut each diaphragm from opposed sided thereof in order to enhance the production of hydrogen and oxygen. Any cell thereby comprises two half cells arranged on each their side of a diaphragm, and each half cell is limited radially by a cell frame 1. The diaphragm 10 is shown as a dashed line, and indeed the diaphragm may comprise tiny openings which allows a flow of ions and/or liquids between the two half cells on each side thereof while, and at the same time, prevents passage of gas bubbles from one to the other side of the diaphragm.

In FIGS. 1, 2, 4, and 5, the inner circumferential rim 4 of a cell frame 1 is seen. The inner circumferential rim 4 is the innermost part of a radial shelf 5. The radial shelf 5 extends inwardly from a mobility link 6, and tapers in an inward direction from the mobility link 6 and towards the inner circumferential rim 4. As seen in FIG. 1, the tapering radial shelves 5 will form an annular space 7 between the radial shelves when cell frames are stacked adjacent to and abutting each other.

The mobility link 6 is seen in enlarged section in FIG. 4, and the link 6 is defined by a furrow 19, which has an outermost (in the direction of the cell frame periphery) diameter 12 and a radial extend d which defines the area where the thickness of the cell frame material is further reduced. The reduction is indicated by arrow h and is no less than 10% of the nominal cell frame thickness, indicated by arrow t, and shall constitute no more than 75% of the cell nominal thickness t. It is possible to construct the furrow 19 even deeper, such that h constitutes up above 99% of the nominal thickness t, leaving no more than a film hinge between the cell frame and the radial shelf. Such a construction may however be impaired by limitations to the injection moulding technique available given the material used in the frames and their size.

The mobility link extends in the radial direction as indicated by arrow d. The extend d is at least commensurate with the further reduced thickness h and no more than three times the reduced thickness h. As seen in FIG. 4, the mobility link furrow 19 has a box-shaped profile in a sectional view of the cell frame 1. However, other types of profiles, such as curved or angled would also work.

When a range of cell frames 1 are stacked as seen in FIG. 3, any two cell frames 1 shall accommodate a bipolar plate 11 and a diaphragm 10 (not displayed in FIG. 3) each spanning the area inside of the inner circumferential rim of the cell frame 4 and extend to the outermost parts of the mobility link. However, the annular space 7 is dimensioned such that the lowest axial distance between consecutive radial shelves 5 in the annular space 7 is somewhat lower than the thickness of the bipolar plate 11. “Somewhat lower” in this connection is to be construed as between 10% and 45% lower, and preferably the distance is nominally 20% lower than the thickness of the bipolar plate. By this measure, it will be ensured that the bipolar plates 11 with their manufacturing tolerances in combination with manufacturing tolerances of the cell frames 1 shall be contacted from two opposed sides by the circumferential radial shelves of neighbouring cell frames when cell frames are urged together in an electrolyser stack 2. Especially when cells in a stack of cell frames are urged against each other by means of pull rods 17, a pressure or sealing force will be provided between the bipolar plates 11 and radial shelves 5 on two opposed sides thereof due to the distance between radial shelves 5 in the annular space 7 being lower than the thickness of the bipolar plate 11.

As seen in FIG. 5, any diaphragm 10 resting in the annular space 7 between two consecutive radial shelves 5 shall have a bipolar plate 11 on each side resting similarly in neighbouring annular spaces 7, and when the cell frames 1 are urged together between two end plates 16 (one of which is shown in FIG. 3) by an array of pull rods 17 by means of tightening nots 18, the cell frames 1 shall not be able to occupy any more space in the length direction of the cell stack than the nominal cell stack length. This cell stack length is given by the nominal thickness of cell frames 1 multiplied by the number of cell frames (see FIG. 5). And as the bipolar plates 11 are made from an alloy such as a nickel alloy, and the diaphragm is made from a compliant material, the mobility link 6 shall allow for the radial shelf 5 to pivot in a direction away from the bipolar plates 11 and towards the diaphragm 10 and elastically compress the diaphragm 10 on either side of the plates 11.

This action will effectively pinch each diaphragm 10 and create a seal between the two sides of any diaphragm. Further, the bipolar plates shall also be pressurised from two sides due to their size being larger than the annular space 7 in which they are fixated around their circumferences. Any two neighbouring half cells in a cell stack 3 shall thus be isolated from each other and no electrolyte shall pass from one half cell to the next even if pressure differences should arise during use of the cell stack 3. It is mentioned that the diaphragms themselves thickness-wise may be oversized or undersized with respect to the annular space between any two cell frames. If oversized, the diaphragm which is somewhat elastic may give way, when cell frames are pressurised towards each other, and if undersized, the movement of the mobility link caused by oversized dipolar plates, shall also pressurise the rim of the diaphragm in the annular space and thereby a seal is provided to prevent fluid flow between the two sides of a diaphragm around the edges thereof. In the disclosed example, the aid of the oversized thickness of the bipolar plates, ensure seals, both around edges of the bipolar plates and around the edges of the diaphragms.

As seen in FIG. 4, grating surfaces 21 are disclosed on both sides of the radial shelf 5. The surfaces are provided to increase the pull-out force on the diaphragm. The grating may be provided as annular ridges rising 0.03 mm-0.05 mm above the surface and evenly spaced on the surfaces. Other kinds of gratings such as bumps, spikes, or the like elements, which increase friction between the radial shelf surfaces and the diaphragm may be used. From FIG. 4, it is also clear that the surfaces 21 will form opposed conical shapes. However, also a stepwise inwardly taper such as in two, three or more steps, where each step is comprised of a flat annular surface part disposed in a plane which extends perpendicular to the axis of the cell stack or cell frame axis. Also, combinations of flat and conical stepwise tapering surfaces may be provided on an upper and a lower surface 21 on upper and love sides of the shelf 5.

A bar-code or alphanumeric code or the like unique identification mark 20 may be added to one or both surfaces of the bipolar plates at the rim part thereof as schematically indicated in FIG. 6. This surface part is to be fixated in the annular space between the radial shelves. Such markings are prone to erosion due to the harsh chemical environment in a cell stack, with highly concentrated lye and potentially high oxygen concentration at elevated temperature. However, in the space between the radial shelf part of bipolar plates, at least the oxygen concentration is expected to be lower, and at least at areas of the rim part of the bipolar plate, which are in pressurised contact with the cell frame material, the corrosive impact of the lye and oxygen is expected to be less pronounced, and surface etchings or laser engravings shall remain readable for a longer time. Preferably the cathode side, where hydrogen is released and the oxygen will be present in week concentration, is used for the identity mark.

It is to be noted that the figures and the above description have shown the example embodiments in a simple and schematic manner. Many of the specific mechanical details have not been shown since the person skilled in the art should be familiar with these details and they would just unnecessarily complicate this description.

### LIST OF PARTS

1 Cell frame
2 Pressurised electrolyser
3 Cell stack
4 Inner circumferential rim of cell frame
5 Radial shelf
6 Mobility link
7 Annular space
8 Supply manifold and discharge manifold
9 O-ring seal
10 Diaphragm
11 Bipolar plate
12 Outer diameter of mobility link furrow
13 Steel ring
14 Cell frame channels
16 End plates
17 Pull rods
18 Tightening nots
19 Mobility link furrow
20 Identity marker
21 Grating surface
t nominal thickness of cell frame
h reduced thickness of mobility link 6
m mobility link thickness t-h
d radial extend of mobility link furrow

1-10. (canceled)

11. An electrolyser cell stack comprising a number of cell frames, wherein the cell frames are configured for use in a pressurized electrolyser cell stack, and wherein, from an inner circumferential rim of the cell frames, a circumferential radial shelf with inwardly tapering thickness protrudes, such that an annular space between a circumferential radial shelf and a neighboring circumferential radial shelf is provided when cell frames are stacked in alignment with each other, wherein outwardly of the circumferential radial shelf, a mobility link is provided, which connects the radial shelf to the remaining cell frame,
wherein the cell frames are urged against each other between endplates and
wherein consecutive cell frames in the cell stack alternatingly support a diaphragm and a bipolar plate,
wherein the annular space is dimensioned such that the lowest axial distance between consecutive radial shelves in the annular space is lower than the thickness of the bipolar plate such as between 10% and 45% lower, and preferably the distance is nominally 20% lower than the thickness of the bipolar plate.

12. The electrolyser cell stack according to claim 11, wherein the mobility link is comprised of an annular radial section with further reduced cell frame material thickness.

13. The electrolyser cell stack according to claim 12, wherein the section with further reduced thickness is no less than 10% and no more than 75% thinner than the nominal cell frame thickness (t).

14. The electrolyser cell stack according to claim 13 wherein the mobility link in the cell frame radial direction extends no less than its further reduced thickness and no longer than three times its further reduced thickness.

15. The electrolyser cell stack according to claim 11, wherein the bipolar plate and the diaphragm both have a diameter which is no larger than the outer diameter of a mobility link furrow and no smaller than the inner diameter of the mobility link furrow.

16. The electrolyser cell stack according to claim 11, wherein the radial shelf is adapted to pivot and/or translate in the axial direction of a cell stack when two cell frames with a bipolar plate between them are urged against each other.

17. The electrolyser cell stack according to claim 16, wherein the diaphragm provided between two neighboring cell frames is adapted to be pinched between the two radial shelves of the two neighboring cell frames when the radial shelves (5) move due to the two bipolar plates arranged at opposed sides of the two neighboring cell frames.

18. The electrolyser cell stack according to claim 17, wherein the annular space between neighboring cell frames covers a rim part of each bipolar plate, whereby the bipolar plate at this rim part comprises an identity marker embedded in the bipolar plate material.

19. The electrolyser cell stack according to in claim 18, wherein the identity marker is provided by laser or etching and is coded for computerized recognition, such as a quick response (QR) code, bar-code or the like.
